(19) United States
(12) Patent Application Publication
(10) Pub. No.: US 2024/0410090 A1
(43) Pub. Date: Dec. 12, 2024

(54) TUBE MAGAZINE

(71) Applicant: Saurer Spinning Solutions GmbH & Co. KG, Übach-Palenberg (DE)

(72) Inventors: Sebastian Thomas, Mönchengladbach (DE); Tai Mac, Würselen (DE); Eduard Prediger, Mönchengladbach (DE)

(73) Assignee: Saurer Spinning Solutions GmbH & Co. KG, Übach-Palenberg (DE)

(21) Appl. No.: 18/680,314

(22) Filed: May 31, 2024

(30) Foreign Application Priority Data
Jun. 6, 2023 (LU) 504424

(51) Int. Cl. D01H 9/18; B65H 49/32

(52) U.S. Cl. CPC D01H 9/18; B65H 49/32; B65H 2515/60

(57) ABSTRACT

A tube magazine for a textile machine, in particular a spinning machine. This can have a plurality of holding devices for bobbin tubes. The textile machine can have at least one marking device. In order to reduce costs, to save resources and to improve the spinning process flow, it is provided that the at least one marking device is designed and arranged to be assigned to a plane between at least two holding devices in such a way that the at least two holding devices are each assigned to a region.

The invention relates to a tube magazine. The invention relates to a textile machine. The invention relates to a machine head of a textile machine. The invention relates to a use of a tube magazine, a textile machine and/or a machine head.

Tube magazines are known from the prior art. In the case of textile machines producing full bobbins, in particular rotor and air-jet spinning machines, bobbin tubes must be supplied to the individual workstation (spinning station) in order to wind up the produced yarn, in particular crosswise. Such bobbin tubes (also referred to as empty tubes) are usually stored in tube magazines of the textile machine on so-called attachment mandrels for automatic supply to the workstation. These tube magazines are usually arranged at the end of the machine.

Nowadays, textile machines are able to produce multiple lots. In other words, different yarn lots can be produced on a single textile machine. A yarn lot is characterized in that it has a yarn with defined yarn properties, so that yarns from different yarn lots have different yarn properties from one another.

The bobbin tubes can be manually attached the respective region of the tube magazine by an operator, which can result in incorrect attachment, which leads to incorrect supply of the incorrectly attached bobbin tubes to the workstations. As a result, either defective bobbins are produced, which must be discarded, or the spinning process has to be stopped. Both lead to an increase in the necessary resources and thus increases costs.

It is the object of the invention to reduce costs and save resources. It is the object of the invention to improve the spinning process flow.

The object is achieved by a tube magazine having the features of claim 1. The object is achieved by a textile machine having the features of claim 10. The object is achieved by a machine head having the features of claim 11. The object is achieved by a use having the features of claim 12.

Advantageous embodiments of the invention are the subject matter of the dependent claims.

According to one aspect, the object is achieved by a tube magazine having the features of claim 1.

A tube magazine for a textile machine, in particular a spinning machine, can have a plurality of holding devices for tubes. The tube magazine can have at least one marking device. The marking device can be designed and arranged to be assigned to a plane which is arranged between at least two holding devices in such a way that the at least two holding devices are each assigned to a region. As a result, the process of a (manual) assignment of bobbin tubes in a tube magazine for an automated supply to a workstation can be improved. As a result, costs can be reduced and resources can be saved. The spinning process flow can also be improved.

So that the different yarn lots can be distinguished, the bobbin tubes can be marked, in particular color-coded, wherein a bobbin tube marking, in particular a bobbin tube color, can be assigned to a yarn lot. The bobbin tubes with a bobbin tube marking, in particular a bobbin tube color, are supplied, in particular automatically, to the workstations that produce the same yarn lot via the tube magazine. The automatic supply is ensured via an input option on a control panel assigned to the textile machine. The control panel is preferably arranged adjacent to the tube magazine. More preferably, the control panel is arranged on a housing element of a housing which at least delimits or receives the tube magazine. Alternatively or additionally, in a preferred embodiment, the control panel can be arranged away from the tube magazine in or on a mobile terminal such as a smartwatch, a laptop, a tablet, a computer unit or a control unit, which is designed to provide defined control commands on the basis of the input via the control panel for the textile machine for the defined control of the textile machine. For the purposes of the present invention, this can be understood to mean a control system having at least one control device and a control panel coupled to this control device for inputting commands from which the control device generates control commands for controlling the textile machine. The control device can preferably be connected to a control device separate from the textile machine, such as a central control device or a workstation device, in order to provide the control commands generated on the basis of the input. According to the preferred embodiment with which the control panel is arranged adjacent to the tube magazine, the control device can form the central control device or the workstation control device. According to these preferred embodiments, defined regions of the tube magazine can each be assigned to a yarn lot that can be produced with the textile machine, so that the bobbin tubes of the bobbin tube marking, in particular the bobbin tube color, which are assigned to the yarn lot, can be attached to these defined regions.

The expression of a plane between at least two holding devices to which the marking device can be assigned is defined in particular as a plane which, for example, delimits two arrangements of regions relative to one another. This can be, for example, a plane that is arranged between two regions, wherein the types of tubes, that are of the same type (in the sense of identical) can each form a region. In a front view of a tube magazine, in particular in a machine head of a textile machine, a region can form a plane of a tube arrangement. This plane can be at an angle, in particular at a right angle, to a plane that is arranged between the regions. In this context, the concept of planes can refer in particular to a mathematical definition of a plane. The planes do not have to be realized (alone or in any combination) by a physical-mechanical representation in the textile machine or a machine head. They serve in particular to assign elements and/or devices in a textile machine or a machine head.

A marking device serves in particular as an aid for identifying which bobbin tubes with which bobbin tube marking, in particular with which bobbin tube color, are to be attached in which regions of the tube magazine. The marking device can be arranged between the at least two holding devices. In other preferred embodiments, the marking device can be arranged in a portion of the plane arranged between the two holding devices in order to be upstream of the holding devices. It can be provided that, from a perspective of an operator, a delimitation of the regions is possible in an attachment method, wherein the operator can directly distinguish between a left and a right of the holding device.

In preferred embodiments, it can be provided that the holding devices are arranged in rows, in particular in such a way that such a row forms a mechanical connection, for example a transport device for the holding devices along the row (in the vertical and/or horizontal direction). The embodiments in relation to the plane which can be arranged between at least two holding devices, a marking device assigned to this plane, and the arrangement of bobbin tubes also apply in a corresponding manner to the rows of such holding devices.

The concept of a region refers in particular to an arrangement of identical bobbin tubes, which can be supplied to at least one workstation in a textile machine, wherein this at least one workstation is assigned to a section, in order to use this at least one workstation or section to spin a defined type of thread and/or yarn, i.e. to produce a defined yarn lot. The bobbin tubes can correspond in their geometry, for example in their circumference, in a cylindrical shape and/or in a truncated cone shape. Additionally or alternatively, however, the bobbin tubes can also correspond in their material, for example. It can be provided that bobbins can be supplied to a region of the at least one workstation or the section of the textile machine that is to produce a defined yarn lot. The workstation or section producing at least one defined yarn lot can be referred to as a working region.

A holding device can in particular be designed and arranged in such a way as to receive at least one bobbin tube. There may be preferred embodiments in which the bobbin tube contacts the holding device with its inner side or a portion thereof. Alternatively or additionally, there may also be preferred embodiments with which an outer side (also referred to as the lateral surface) or a portion thereof can be contacted by the holding device.

A (manual) assignment of bobbin tubes in a tube magazine for an automated supply to a workstation can be improved, since a color coding on a lower edge of a tube magazine as an indication can lead to the fact that, despite this indication, bobbin tubes of one color can always be attached to a region of the tube magazine which is assigned to a different working region than the color to which the attached bobbin tube is assigned. This occurs in particular in the case of holding devices, in particular in the form of rows of attachment mandrels, which are arranged next to one another in the tube magazine. A defined number of adjacent holding devices, in particular in the form of rows of attachment mandrels, can be assigned to a working region, as a result of which a region can be formed as described elsewhere. For example, three adjacent holding devices can be assigned to a first working region, wherein a further holding device adjacent thereto can be assigned to another, second working region. It can happen that the operator attaches bobbin tubes with a bobbin tube marking, in particular with a bobbin color, to this further holding device, which is assigned to the first working region. The marking device proposed here can in particular be designed in such a way that an operator can perceive the marking device in an operating method, in particular can perceive it visually, in particular at an attachment height. In one method step, for example, the bobbin tubes can be assigned to the regions to which they “belong” in a defined manner. A continuous control function can be carried out by the operator while assigning the bobbin tubes to the respective regions.

According to a preferred aspect, at least one of the following arrangements can be designed as an arrangement of the at least one marking device. The at least one marking device can be arranged in a vertical direction in a plane which runs between two rows of holding devices. Alternatively or additionally, the at least one marking device can be arranged in a horizontal direction in a plane which runs between two rows of holding devices. As a result, a marking device can be arranged in a simple manner, which marking device allows the regions to be delimited from one another, in particular visually. As a result, a continuous control function can be carried out by the operator, while assigning the bobbin tubes to the respective regions. In particular, the operator can perceive a left from a right to the marking device during an attachment step and include it in the decision-making process. As a result, the process of a (manual) assignment of bobbin tubes in a tube magazine for an automated supply to a workstation can be improved. As a result, costs can be reduced and resources can be saved. The spinning process flow can also be improved.

The horizontal and vertical directions (also referred to as the horizontal or vertical arrangement) are defined in particular in relation to the installation of a textile machine. A horizontal direction can be defined in particular in the form of a width or depth of the textile machine. Alternatively or additionally, a vertical direction can be defined in the form of a height of a textile machine.

According to a preferred aspect, the at least one marking device can be designed as a flexible marking device. Alternatively or additionally, the at least one marking device can be designed as a rigid marking device. As a result, the structure of the marking device can be designed to be adapted to the conditions at the tube magazine.

According to a preferred aspect, the at least one marking device can be designed to be inserted into holders in the tube magazine. As a result, the at least one marking device can be arranged. The need for particularly extensive structural changes to the textile machine or to the machine head in order to arrange a marking device can be avoided. The holders in the tube magazine can be designed to arrange the marking devices on the textile machine. In particular, locking devices can be formed-in particular on the marking device, as well as in particular corresponding counterparts on the tube magazine, the textile machine and/or a machine head, as described elsewhere-on which the marking devices can be arranged. Locking devices can be selected, for example, from screws, nails, rivets, hooks, eyelets and/or corresponding counterparts on the tube magazine, the textile machine, the machine head and/or the marking device.

A marking device can be assigned directly to a holding device. There can be preferred embodiments in which the marking device is designed to be connected to a holding device in such a way that the marking device is connected to a transport device, in particular in a vertical or a horizontal direction.

According to a preferred aspect, the marking device can have an indicator, in particular a color coding. This indicator can correspond to an indicator, in particular in the form of a color coding, which is assigned to a type of bobbin tube to be arranged in at least one of the regions. An assignment can correspond directly to an arrangement on a holding device. Alternatively or additionally, a marking device can be provided which, as already described elsewhere, can be arranged on a tube magazine and/or on a machine head (as described elsewhere).

In particular, at least two different functions are formed by a marking device as described here and elsewhere. A first preferred function in particular provides an identification of a separation or delimitation of the regions relative to one another. In particular, a first region can be delimited from a second region. The delimitation can be mechanical, for example by drawing in separating structures and/or separating devices as described elsewhere. Alternatively or additionally, marking devices can be designed to visually indicate a delimitation. As a second preferred function, it can be provided that a type of bobbin tube can be specified in at least one of the regions. For example, an indicator can refer to a configuration of bobbin tubes that are to be arranged in the at least one region. The indicator can also transmit information in particular as to which type of bobbin tube is to be arranged in the at least one region.

According to a preferred aspect, the at least one marking device can have at least one of the following: a band, in particular an expander, a bar, a chain, a rod and/or a metal sheet, in particular a partition wall. As a result, at least one of the various functions described elsewhere in relation to the marking device can be implemented.

A band can in particular be a flexible form of a marking device. The band can be made of rubber and/or plastic. Alternatively or additionally, a band can also be made of a material such as a textile. The textile can be spun from threads of a yarn and/or from threads of a metal. An expander can in particular be an elastic band which can be pulled in length and automatically returns to its original length, as a result of which it can be arranged between two locking devices as described elsewhere. An arrangement is particularly easy to enable, as a result of which a change can be carried out quickly. A band can have at least one indicator as described elsewhere.

A bar can in particular be an example of a rigid marking device. A bar can be more stable, such as a band, as a result of which an arrangement remains stable even under greater load, for example if an operator bumps into it when attaching the bobbin tubes. A bar can have at least one indicator as described elsewhere.

A chain can in particular be designed to combine the properties of a rigid marking device with the properties of a flexible marking device. The chain can in particular be tensioned or not tensioned (such as an expander) and, alternatively or additionally, have a certain flexibility in a width or depth direction of the textile machine. At least one indicator can be arranged on the chain as described elsewhere.

A rod and/or a metal sheet, in particular a partition wall, can be designed to form a mechanical separation, as an example of a rigid form of a marking device. A rod and/or a metal sheet, in particular a partition wall, can have indicators as described elsewhere.

According to a preferred aspect, the marking device can have an indicator, in particular as already mentioned elsewhere. An indicator can in particular have a color coding. The indicator on the marking device can correspond to an indicator of a type of tube to be arranged in at least one of the regions. The corresponding indicator which can be assigned to the bobbin tube is in particular designed in the form of a color coding. The corresponding indicator on the marking device, in particular the corresponding color coding, can point in the direction of the respective region of the bobbin tube magazine in which the bobbin tubes with a corresponding indicator are to be arranged. Particular reference is made here to the advantages and properties of the indicator as described elsewhere. A repetition of text passages is dispensed with for reasons of readability and compactness.

According to a preferred aspect, the marking device can be designed in such a way that it is arranged at an arrangement height. As a result, the marking device can be assigned to an arrangement of the bobbin tube. As a result, an allocation can be highlighted, which makes it easier for an operator to correctly classify the assignment and to arrange the correct bobbins.

An arrangement height can in particular be an attachment height. An attachment height corresponds in particular to an arrangement height (in particular in a fully attached state) in preferred embodiments in which the holding device in particular allows bobbin tubes to be attached as described elsewhere.

The arrangement height can be understood in particular as a distance between a holding device and a floor in an installed textile machine. The marking device can be arranged in a fixed manner, for example in preferred embodiments in which the same bobbins are repeated again and again in an arrangement of a region. However, there can also be preferred embodiments with which a region changes its function. In particular, a marking device can move with a holding device for bobbin tubes when these holding devices move, as described elsewhere.

The marking device can in particular project into a field of vision of an operator. An average height of an operator, in particular with a relaxed posture, can follow the information on common occupational safety in Germany and/or the EU, as described on the filing date or priority date. In particular, it can be assumed that the eye position is relaxed (looking straight ahead).

According to a preferred aspect, at least one example tube can be assigned to a region as a further marking device. This can be in particular below and/or above the at least one region as described elsewhere. As a result, a visualization of an example tube can be designed as a direct comparison. As a result, it can further facilitate an operator in aligning the bobbin tubes to be attached with the further marking device (also referred to as a dummy).

According to an independent aspect, the object is achieved in particular by a textile machine. This in particular has a tube magazine as described elsewhere. The textile machine can be described by the features, properties and advantages of the tube magazine. Reference is made in this context to these embodiments, and a repetition of the associated text passages is dispensed with for reasons of compactness and readability. The textile machine can be described by the features, properties and advantages of a machine head as explained elsewhere. The textile machine can be described by the features, properties and advantages of a use as explained elsewhere.

The textile machine can in particular be a spinning machine. The spinning machine can be a rotor spinning machine or an air-jet spinning machine. The spinning machine can preferably have a plurality of workstations. These can be arranged or divided into sections, wherein in particular at least one workstation is assigned to a section. The at least one workstation or section can be designed as described elsewhere to spin a defined type of thread/yarn, i.e. to produce a defined yarn lot. The workstation or section producing at least one defined yarn lot can be referred to as a working region. The tube magazine can in particular be arranged in a machine head. A corresponding region is preferably formed in a tube magazine in order to receive the bobbin tubes that can be supplied to such a working region. A plurality of working regions can be formed on a textile machine in order to spin a plurality of types of threads or yarns. As a result, a plurality of regions can be formed in a tube magazine.

According to an independent aspect, the object is achieved in particular by a machine head of a textile machine. The textile machine is in particular designed as described elsewhere. The machine head can have a tube magazine as described elsewhere. The machine head is in particular formed on an end face of a textile machine. Thanks to its design, the textile machine can therefore simulate a spinning process of at least one defined type of thread or one defined type of yarn. The machine head of the textile machine can be described by the features, properties and advantages of the tube magazine. Reference is made in this context to these preferred embodiments and a repetition of the associated text passages is dispensed with for reasons of compactness and readability. The machine head can be described by the features, properties and advantages of the textile machine as explained elsewhere. The machine head can be described by the features, properties and advantages of a use as explained elsewhere.

According to an independent aspect, the object is achieved in particular by using a tube magazine as described elsewhere, a textile machine as described elsewhere, and/or a machine head as described elsewhere. At least two bobbin tubes of two types of bobbin tube can each be assigned to a region. The regions can be marked by a marking device. The marking device can be designed and arranged to be assigned to a plane between the at least two holding devices, in particular in such a way that the at least two holding devices are each assigned to a region. The use of the tube magazine, the textile machine and/or the machine head can be described by the features, properties and advantages of the tube magazine, the textile machine and/or the machine head. Reference is made in this context to these preferred embodiments and a repetition of the associated text passages is dispensed with for reasons of compactness and readability.

In summary and in other words, this means that in textile machines producing full bobbins, in particular rotor and air-jet spinning machines, bobbin tubes can be supplied to the individual workstations (spinning stations) in order to wind up the produced yarn or thread, in particular crosswise. Such bobbin tubes are stored in particular in tube magazines of the textile machine, for example on so-called attachment mandrels as holding devices for automatic supply to the workstation. These tube magazines are arranged in particular at the end of the machine, for example in a machine head.

The textile machines are in particular capable of producing multiple lots. In other words, different yarn lots (types of yarn) can be produced on a single textile machine, in particular on one long side of the textile machine. A yarn lot is characterized in particular in that it has a yarn with defined yarn properties, so that yarns from different yarn lots can have different yarn properties from one another.

So that the different yarn lots can preferably be visually distinguished, the bobbin tubes can be marked. In preferred embodiments, such a bobbin tube marking can be a color coding, wherein a bobbin tube color can be assigned to a yarn lot.

In particular, the bobbin tubes of one color are supplied to the workstations that produce the same yarn lot via the tube magazine. Defined regions of the tube magazine are each assigned to a yarn lot, so that the bobbin tubes of the color that are assigned to the yarn lot are to be attached in these defined regions. At least one workstation, more preferably a plurality of workstations, can be arranged to form a working region, wherein at least one workstation can make up one section, wherein a plurality of workstations is preferably divided into different sections of the textile machine. The working region can in particular be designed in such a way that the at least one workstation arranged therein or the at least one section is designed or configured to form a defined yarn lot.

The bobbin tubes can be manually attached to the respective region of the tube magazine by an operator. Despite aids, such as the color coding of the bobbin tubes and/or a color coding on the underside of the tube magazine, for marking in which regions of the tube magazine which colors of bobbin tubes are to be attached, incorrect attachment can occur.

In other words, despite instructions, bobbin tubes of one color can always be attached to a region of the tube magazine, even though this color is assigned to a different working region than that of the attached bobbin tube. This occurs in particular in the case of rows of holding devices, for example in the form of rows of attachment mandrels, which are arranged adjacent to another in the tube magazine, wherein a defined number of adjacent rows, in particular of attachment mandrels, can be assigned to a working region. For example, three adjacent rows, in particular of attachment mandrels, can be assigned to a first working region, wherein a further row adjacent thereto, in particular of attachment mandrels, can be assigned to another, second working region. It can happen that the operator attaches bobbin tubes with a color that is assigned to a different working region to this additional row, in particular of attachment mandrels.

By arranging flexible or rigid visual marking devices (also referred to as separations) between the regions of the tube magazine, the assignment of the regions can be identified and this can make it easier for an operator to correctly assign and arrange bobbin tubes accordingly. The marking devices can be rigid bars or flexible bands such as expanders. The marking devices are used in particular at the end in holders provided in the tube magazine. As a result, when attaching the bobbin tubes, the operator is in particular visually prompted to only insert the bobbin tube of the same color into the region of the tube magazine that is on one side of the marking device(s).

In preferred embodiments, the marking device can have color indicators corresponding to the bobbin tube color, wherein these indicators can be arranged in such a way that they point in the direction of the respective region of the tube magazine to which bobbin tubes with a color that is the same as the indicator color are to be attached.

In the following, preferred exemplary embodiments are described in more detail with reference to figures, showing schematically and by way of example:

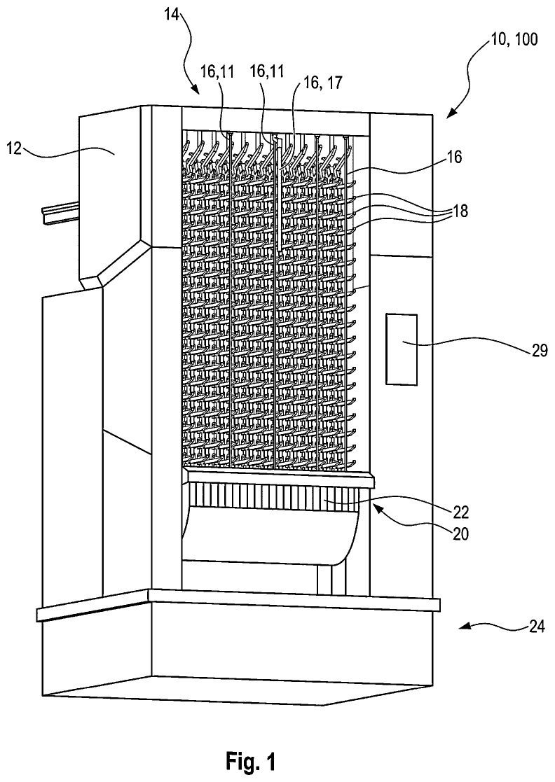

FIG. 1 a schematic representation of a preferred embodiment of a machine head of a textile machine;

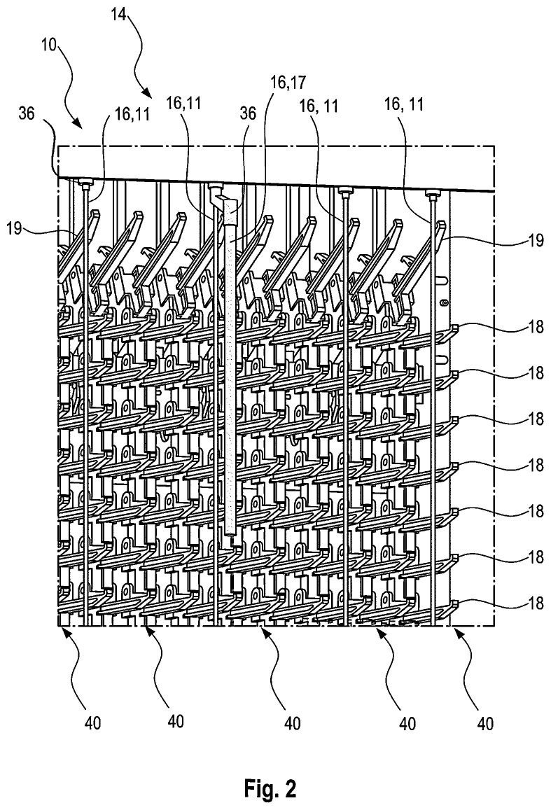

FIG. 2 a schematic representation of a section of a preferred embodiment of a tube magazine, and

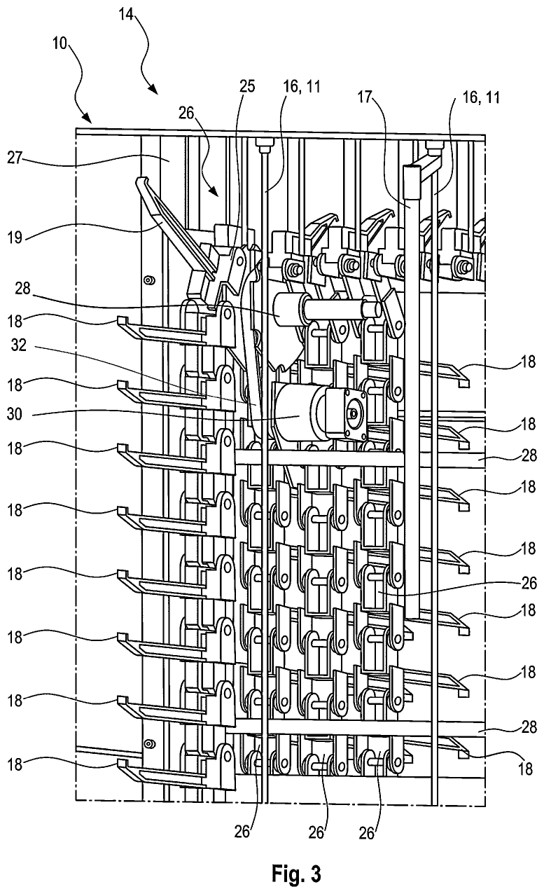

FIG. 3 a schematic representation of a section of a further preferred embodiment of a tube magazine.

The same reference signs are used for elements and structures having the same effect and/or of the same type.

FIG. 1 shows an exemplary embodiment of a machine head 10 of a textile machine 100. A machine head 10 forms in particular an end face of the textile machine 100, on which working regions (not shown) are arranged in a known manner.

A tube magazine 14 is assigned to the machine head 10. The assignment can in particular be formed by arranging the tube magazine 14 in this machine head 10. A housing 12 can be formed in order to arrange a tube magazine 14 therein. The textile machine 100 or the machine head 10 are arranged on a base 24. As a result, stability is particularly imparted to the structure.

The tube magazine 14 for the textile machine 100 has in particular a plurality of holding devices 18 for bobbin tubes (not shown). At least one marking device 16 can be provided. This marking device 16 can be designed and arranged to be assigned to a plane between at least two holding devices 18. This plane lies here, for example, as an imaginary plane between the holding devices 18. The holding devices 18 are designed here as attachment mandrels 19, as shown in detail in FIG. 2. The assignment can particularly be such that each of the at least two holding devices 18 is assigned to one region 40.

The marking devices 16 are in particular designed to extend in a vertical direction between a row of holding devices 18. The marking device 16 extends in particular over the entire height of the tube magazine 14 and is thus designed in particular in such a way that it projects into a field of vision of an operator (not shown) at an arrangement height.

Two types of marking devices 16 are shown in the embodiments shown in FIGS. 1 to 3. These can be used together (as shown here) or separately. These can be a flexible marking device 11 or a rigid marking device 17. Both types of marking devices 11, 17 can be inserted into holders 36 in the tube magazine 14. These holders 36 can be adapted to the marking device 16. Insertion can involve clamping, in particular in the case of the flexible marking devices 11. The rigid marking devices 17 can be inserted, plugged and/or screwed into the holder 36. Examples of marking devices 16 can be a band, in particular an expander, a bar, a chain, a rod and/or a metal sheet, in particular a partition wall.

The marking device 16 can have an indicator (not shown), in particular a color coding, which corresponds to an indicator (not shown), in particular a color coding, which is assigned to a type of bobbin tube to be arranged in at least one of the regions 40. The corresponding indicator, in particular the corresponding color coding, can point in the direction of the respective region 40 of the tube magazine 14 in which the bobbin tubes with a corresponding indicator are to be arranged.

FIG. 2 shows in particular in a schematic representation a section of an embodiment of a tube magazine 14. Attachment mandrels 19 are arranged in rows on a chain 26 as a holding device 18, as shown in further detail in FIG. 3. A chain 26 is formed in particular from a series of chain links 25 that can be tilted from one another. FIG. 2 in particular shows a row of vertically extending chains 26 which are arranged next to one another in order to arrange the attachment mandrels 19 as holding devices 18 in the tube magazine 14. FIG. 3 shows in particular a section of an embodiment of a tube magazine 14 with which a portion of the chains 26 is hidden in order to explain the functionality. The chains 26 run in particular over deflection rollers (not shown). The deflection rollers are mechanically connected to a motor 30 via a belt 32 in order to be able to set the chains 26 in motion. As a result, bobbin tubes can in particular be resupplied, if necessary, in a working region (not shown) of the textile machine 100. The overall structure can be stabilized by support structures 27 and cross struts 28.

A tube magazine 14 as described here and elsewhere can be used in a textile machine 100 and/or in a machine head 10 in order to assign each of at least two bobbin tubes of two types of bobbin tube to a region 40 using a marking device 16. The regions 40 are in particular marked by a marking device 16. The marking device 16 is in particular designed and arranged to be assigned to a plane between the at least two holding devices 18 in such a way that the at least two holding devices 18 are each assigned to a region 40.

“Can” in particular refers to optional features of the invention. Accordingly, there are also developments and/or exemplary embodiments of the invention which additionally or alternatively have the respective feature or the respective features.

From the combinations of features disclosed in the present case, isolated features can also be taken as needed and used by resolving a structural and/or functional relationship possibly existing between the features in combination with other features for delimiting the subject matter of the claim.

### LIST OF REFERENCE SIGNS

10 Machine head
11 Flexible marking device
12 Housing
14 Tube magazine
16 Marking device
17 Rigid marking device
18 Holding device
19 Attachment mandrels
20 Lower capping
22 Further marking device
24 Base
25 Chain link
26 Chain
27 Support structure
28 Cross strut
29 Control panel
30 Motor
32 Belt
36 Holder
40 Region
100 Textile machine

1. A tube magazine for a textile machine comprising:
a plurality of holding devices each for receiving a bobbin tube; and
at least one marking device;
wherein the at least one marking device is designed and arranged to be assigned to a plane which is arranged between at least two holding devices in such a way that the at least two holding devices are each assigned to a region.

2. The tube magazine according to claim 1, wherein:
the at least one marking device is arranged in a vertical direction in a plane which runs between two rows of the at least two holding devices; and/or
the at least one marking device is arranged in a horizontal direction in a plane which runs between two rows of the at least two holding devices.

3. The tube magazine according to claim 1, wherein:
the at least one marking device is designed as a flexible marking device; or
the at least one marking device is designed as a rigid marking device.

4. The tube magazine according to claim 1, wherein the at least one marking device is designed to be insertable into holders in the tube magazine.

5. The tube magazine according to claim 1, wherein the at least one marking device has a first indicator corresponding to a second indicator of a type of bobbin tube to be arranged in the region.

6. The tube magazine according to claim 1, wherein the at least one marking device has at least one of the following:
a band;
a bar;
a chain;
a rod; and
a metal sheet.

7. The tube magazine according to claim 1, wherein the at least one marking device has a first indicator corresponding to a second indicator of a type of bobbin tube to be arranged in the region, wherein the first indicator points in a direction of the region of the tube magazine in which the bobbin tube with a the second indicator are to be arranged.

8. The tube magazine according to claim 1, wherein the at least one marking device is designed to be arranged at an arrangement height in order to project into a field of vision of an operator.

9. The tube magazine according to claim 1, wherein at least one example tube is assigned to the region.

10. A textile machine having the tube magazine according to claim 1.

11. A machine head of a textile machine wherein the machine head has the tube magazine according to claim 1.

12. A use of a tube magazine according to claim 1, wherein at least two bobbin tubes of two types of bobbin tube are each assigned to the region, wherein the region is marked by a marking device, wherein the marking device is designed and arranged to be assigned to a plane between the at least two holding devices in such a way that the at least two holding devices are each assigned to the region.

13. The tube magazine according to claim 5, wherein the first indicator and the second indicator are a color coding.

14. The tube magazine according to claim 7, wherein the first indicator and the second indicator are a color coding.
